(19) United States
(12) Patent Application Publication
(10) Pub. No.: US 2013/0186720 A1
(43) Pub. Date: Jul. 25, 2013

(54) BRAKE SHOE FOR A DRUM BRAKE

(71) Applicant: Attiglio Cantarelli, Kwa-Zulu Natal (ZA)

(72) Inventor: Attiglio Cantarelli, Kwa-Zulu Natal (ZA)

(73) Assignee: DYNOTHERM (PTY) LIMITED, Kwa-Zulu Natal (ZA)

(21) Appl. No.: 13/806,567

(22) PCT Filed: Jun. 29, 2011
(86) PCT No.: PCT/IB11/52858

§ 371 Date: Apr. 11, 2013

(30) Foreign Application Priority Data
Jun. 29, 2010 (ZA) 2010/04568

(51) Int. Cl. F16D 65/09

(52) U.S. Cl. CPC F16D 65/09
USPC 188/250 G

(57) ABSTRACT

A brake shoe for a drum brake (10) has: a generally arcuate spine (12) defining an arc plane and having attachment means (14, 16) for attaching the brake shoe (10) to a backing plate (18) of the brake drum (20); at least one carrier (14, 16) attached to the spine (12) and adapted to receive an element of a frictional braking material (42) inserted transversely with respect to the arc plane of the spine (12); and locking means (40) for releasably locking the frictional element (42) in place on the at least one carrier (14, 16), the locking means (40) being accessible for actuation from a position lateral with respect to arc plane of the spine (12), thereby permitting the removal and replacement of the frictional element from its respective carrier (14, 16) from a lateral position with respect to the spine.

### FIELD OF THE INVENTION

The field of the invention relates to braking. More particularly, the invention relates to a brake shoe. In particular, the invention relates to a brake shoe for use, preferably, but not exclusively, in drum brake systems for heavy vehicles. The invention extends to a drum brake incorporating at least one brake shoe and to a replaceable frictional element for such brake shoe.

### BACKGROUND TO THE INVENTION

Drum brakes and disc brakes are well-known for use in the braking of vehicles of various sorts. While disc brakes have become increasingly common, particularly for light vehicles, there is still an application for drum brakes in heavy duty and off-road vehicles. In these latter applications, drum brakes provide certain advantages, including the even dissipation of heat and the ability to apply the large brake forces required to brake heavy vehicles.

The refurbishment of wear parts in vehicle fleets is an important aspect of fleet management. In particular, brake shoes are generally refurbished from time to time rather than being discarded and replaced with new components. The refurbishment of brake shoes is well-known in the industry. Generally, the entire brake shoe is removed from the vehicle and sent to a refurbisher for the replacement of the lining of the shoe. The old worn lining is removed from the brake shoe and is replaced with a new lining, which is generally either bonded or riveted to the shoe. The removal of the break lining may require abrasive, mechanical or chemical treatment and the shoe may be damaged in the process. The refurbished shoe is then sent back to the end user and refitted to the vehicle from which it was moved. All of this is time consuming and, in order to limit vehicle downtime, the operator of the vehicle is required to maintain a stock of brake shoes that can be swopped in and out of vehicles while worn shoes are refurbished. In addition, the removal of an entire brake shoe requires substantial dismantling of the wheel and brake drum of a vehicle, which is again time consuming and costly.

A further disadvantage of commonly used drum brake systems on heavy vehicles is that the contact surface between the brake shoes and brake drum of a wheel of the vehicle is not evenly distributed about the brake drum. As a consequence, when a vehicle is brought to rest after heavy braking, which has resulted in the heating up of the brake drum, certain areas of the brake drum will remain in contact with the brake shoes, while other areas of the brake drum are not in contact with the brake shoes. This results in uneven cooling of the brake drum and eventually in distortion of the drum itself: Instead of being round, brake drums tend to take distorted oval shape after substantial use. Such drums need to be replaced or refurbished by machining in order to bring them back to their true condition.

It would therefore be an advantage to provide a brake shoe that would facilitate refurbishment; minimize the amount of downtime required to provide new lining for the brake shoe; and provide for a relatively even distribution of contact surfaces between the linings of the brake system and the brake drum to facilitate even cooling of the drum.

It would be a further advantage to provide a brake lining of an improved material and a brake shoe incorporating such an improved brake lining.

### OBJECT OF THE INVENTION

It is an object of this invention to provide a brake shoe that will, at least partially, overcome the abovementioned disadvantages and achieve the stated advantages.

### SUMMARY OF THE INVENTION

According to a first aspect of the invention there is provided a brake shoe for a drum brake, the brake shoe including
a generally arcuate spine defining an arc plane and having attachment means for attaching the brake shoe to a backing plate of the brake drum;
at least one carrier attached to the spine and adapted to receive an element of a frictional braking material inserted transversely with respect to the arc plane of the spine; and
locking means for releasably locking the frictional element in place on the at least one carrier, the locking means being accessible for actuation from a position lateral with respect to arc plane of the spine, thereby permitting the removal and replacement of the frictional element from its respective carrier from a lateral position with respect to the spine.

Preferably, the brake shoe has a plurality of carriers spaced along the spine. Then, the carriers may be spaced such that when a pair of brake shoes is in place within a brake drum the frictional elements of the brake shoes are generally evenly spaced about the circumference of the brake drum.

The, or each, carrier may include a pair of spaced apart side walls with inwardly projecting lips and the respective elements of frictional material may have recesses on opposed sides thereof, each frictional element being slidingly received within its respective carrier so that the lips engage with the recesses.

The opposed side walls of the carriers may be parallel with each other and generally transverse to the spine of the brake shoe. Instead, pairs of side walls may be angled to provide a tapered keyway for a respective frictional element and the frictional element may taper inwardly from its proximal to its distal end.

The, or each, carrier may have a passageway defined therein, the passageway being generally transverse to the spine of the brake shoe and co-parallel with the walls of its associated carrier; and the locking means may comprise a fastener that is received within the passageway and opposed ends of which are adapted to be tightened against the opposed proximal and distal ends of the respective frictional element associated with each carrier. Then, the fastener may comprise a headed bolt having a threaded free end, a pair of washers and a nut, the washers bearing against opposed ends of the frictional element when the nut is tightened on the bolt and thereby preventing lateral movement of the frictional element with respect to the spine.

In a preferred embodiment of the invention, the, or each, frictional element is of a sintered material. Further, preferably, the, or each, frictional element is manufactured in a production process that creates no, or minimal, airborne fibres and does not require the use of phenol resins.

The invention extends to a drum brake incorporating at least one brake shoe as hereinbefore described and to a replaceable frictional element adapted for use in a brake shoe as hereinbefore described.

### BRIEF DESCRIPTION OF THE DRAWINGS

The invention will be described, by way of example only, with reference to the drawings in which:

FIG. 1 shows a perspective view of a brake shoe in accordance with the invention;

FIG. 2 shows a side view of the brake shoe of FIG. 1;

FIG. 3 shows an end view of the brake shoe of FIG. 1; and

FIG. 4 shows a side view of a pair of brake shoes in accordance with the invention, in place in a drum brake, the brake drum having been removed.

### DETAILED DESCRIPTION OF THE DRAWINGS

The invention is now described, by way of example, with reference to the accompanying diagrammatic drawings. In the drawings, a brake shoe in accordance with the invention is generally indicated by reference numeral 10.

The brake shoe 10 has an arcuate spine 12, which lies in and defines an arc plane. Connectors 14,16 for connecting the brake shoe 10 in a conventional manner to the back plate 18 of a drum brake 20 (as shown in FIG. 4) are provided at each end of the spine 12. A first pair of connectors 14 comprises two spaced lugs 22 having arcuate recesses 24 defined therein and a second pair of connectors 16 comprises two spaced lugs 26 formations having apertures 28 defined therein. These connectors 14,16 allow the brake shoe 10 to be retrofitted to conventional drum brakes 20 in a manner that is well known and will not be further elaborated upon herein.

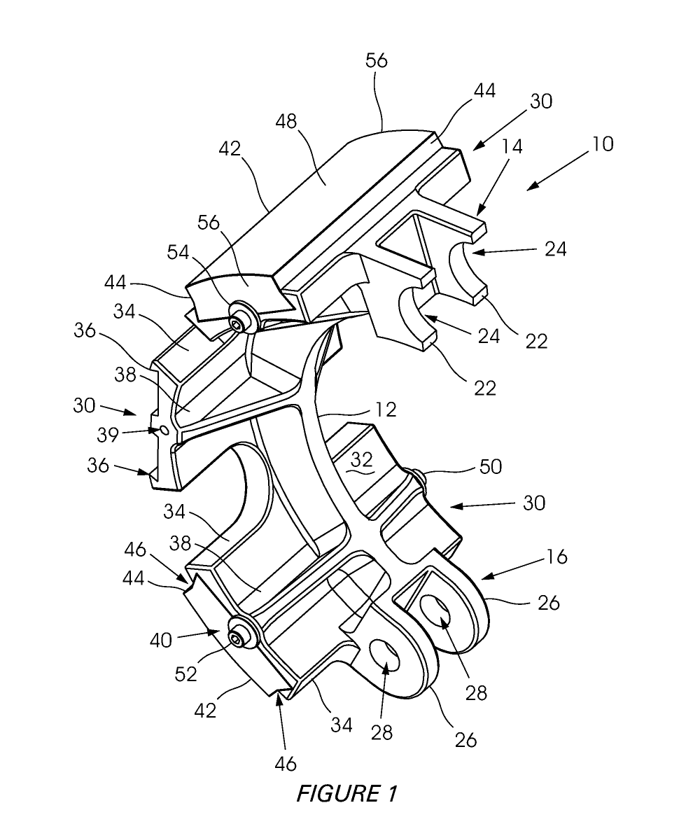

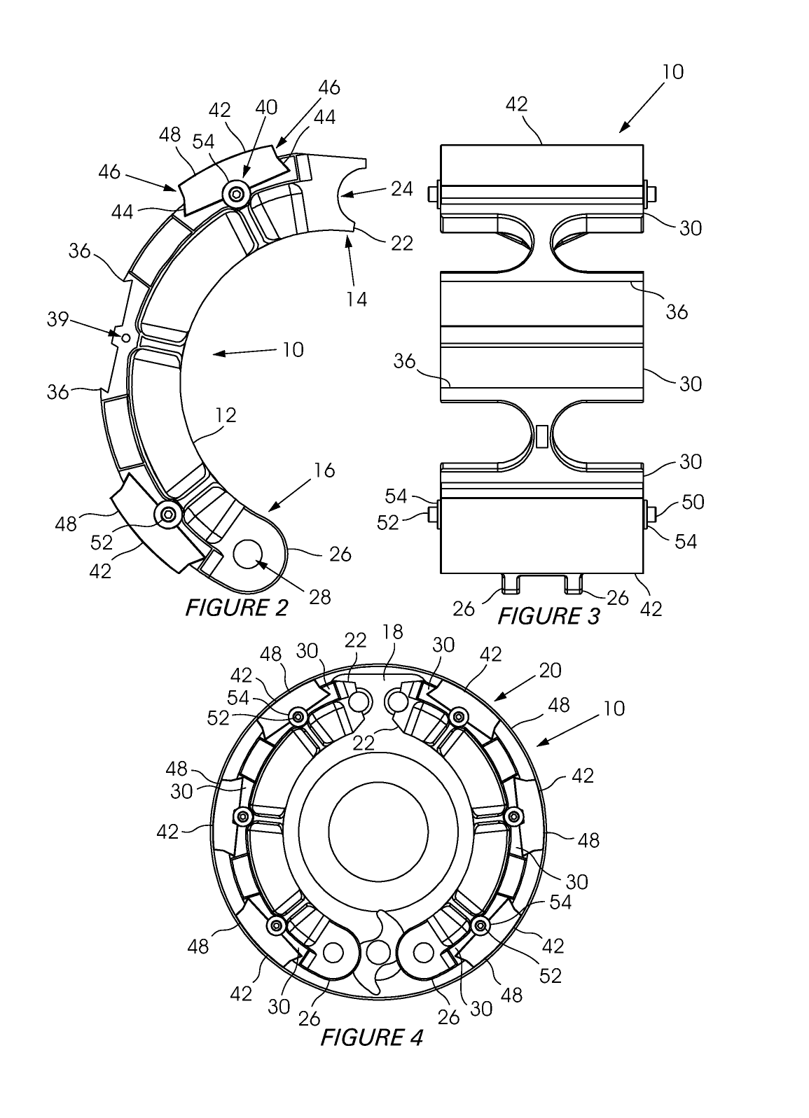

Three carriers 30 spaced along the length of the spine 12, each of the carriers being transversely orientated in a rib-like manner with respect to the arc plane of the spine 12. Each of the carriers 30 comprises a base 32 having a pair of side walls 34 extending therefrom. Each of the side walls 34 has an inwardly projecting lip 36 (shown in FIGS. 1 and 2) extending therefrom. In addition, each of the carriers 30 has a formation 38 attached to the base 32 of the carrier 30 in which is defined a passageway 39 for receiving a fastener 40.

Elements 42 of frictional material are received within the carriers 30. The frictional elements 42 comprise generally rectangular blocks of frictional material, opposed sides 44 of which have recesses 46 defined therein. When inserted into its associate carrier 30, the exposed upper face 48 of the frictional element 42 is curved to accommodate the curvature of the brake drum (not shown) with which the brake shoe 10 co-operates, in use. Each of the frictional elements 42 is inserted into its associated carrier 30 by sliding it from a lateral position with respect to the arc plane of the spine 12 so that the recesses 46 of opposed sides 44 of the frictional element 42 underlie and engage with respective lips 36 of the side walls 34 of the carrier 30. Once in place, the lips 36 of the carrier 30 prevent movement of the frictional element 42 either diametrically with respect to the arc of the spine 12, under centrifugal forces, or angularly along the spine 12, under frictional braking forces. Once in place, the frictional elements 42 are locked in place by means of a fastener 40 comprising a headed bolt 50 with is inserted within the passageway 39 of the carrier 30, a threaded end of the bolt 50 being engaged by means of a nut 52 or other suitable fastener. Washers 54, which may be loose or attached to the head of the bolt 50 and the nut 52, provide a bearing surface butting against opposed ends 56 of the frictional element 42 when the nut 52 is tightened on the bolt 50. Thus the frictional element 42 is prevented from movement transverse to the spine 12.

As may be seen from FIG. 4, the frictional elements 42, which effectively comprise brake linings, may be removed and replaced when they have deteriorated as a result of wear and tear, by removing the brake drum (not shown) from the wheel of the vehicle (not shown) and loosening the fasteners 40 from respective carriers 30. Worn frictional elements 42 may then be removed and replaced with new ones without having to remove the entire brake shoe 12 from the drum brake 20. This, it will be appreciated, results in an appreciable saving of time and effort in replacing worn brake linings. It will be further appreciated that, as illustrated in FIG. 4, the frictional elements 42 may be spaced on their respective brake shoes 12 in such a way that when the brake shoes 12 are in place, as shown in FIG. 4, frictional elements 42 are generally evenly circumferentially spaced about the brake drum. While it may not be possible to provide a completely evenly spacing of the frictional elements 42 about the drum, because of having to accommodate the design of existing brake drums, spacing of the brake linings comprising the frictional elements 42 about the drums will generally be more even than would be the case with conventional brake linings.

The use of modern sintered materials allows the manufacture of removable frictional elements 42, or brake linings, that require no bonding or riveting of the brake shoe 12. In addition, the manufacture of such brake linings may be accomplished in such a manner that no, or minimal, airborne fibres are created in the manufacturing process and the use of phenol resins is avoided. Both of these are aforementioned will improve the health and safety aspects in the manufacture of brake linings.

The use of replaceable linings of the sort described avoids the necessity for burning-off glue on brake shoes when these are refurbished by refurbishers. In fact, there is no need for off-site refurbishment of brake shoes. This results in reduction of brake change downtime, since there is no need to remove brake shoes 12 from the axel of the vehicle and no need to send the shoes 12 to a bonder for riveting or bonding. In addition, the brake lining elements 42 may be manufactured to high tolerances and are ready for use upon insertion, obviating the need for burnishing or bedding-in or even radius profiling. Brakes using the brake shoes of the invention have been found to outperform disc brakes, having an increased specific heat capacity and an increased load capability. Sintered materials can withstand temperatures of around 600° C. and thermal spikes of up to 800° C. In addition, it has been found that the use of the brake shoes 12 of the invention leads to significant improvements in drum life, owing to the more even distribution of thermal loading. In addition, brakes adopting the brake shoes of the invention have been found to handle higher duty cycles than existing drum and disc brake configurations in heavy vehicles.

1. A brake shoe for a drum brake, the brake shoe including
a generally arcuate spine defining an arc plane and having attachment means for attaching the brake shoe to a backing plate of the brake drum;
at least one carrier attached to the spine and adapted to receive an element of a frictional braking material inserted transversely with respect to the arc plane of the spine; and
locking means for releasably locking the frictional element in place on the at least one carrier, the locking means being accessible for actuation from a position lateral with respect to arc plane of the spine, thereby permitting the removal and replacement of the frictional element from its respective carrier from a lateral position with respect to the spine.

2. The brake shoe as claimed in claim 1 in which a plurality of carriers is spaced along the spine.

3. The brake shoe as claimed in claim 2 in which the carriers are spaced such that when a pair of brake shoes is in place within a brake drum the frictional elements of the brake shoes are generally evenly spaced about the circumference of the brake drum.

4. The brake shoe as claimed in any one of the preceding claims in which the, or each, carrier includes a pair of spaced apart side walls with inwardly projecting lips and the respective elements of frictional material have recesses on opposed sides thereof, each frictional element being slidingly received within its respective carrier so that the lips engage with the recesses.

5. The brake shoe as claimed in claim 4 in which opposed side walls of the carriers are parallel with each other and generally transverse to the spine of the brake shoe.

6. The brake shoe as claimed in claim 4 in which pairs of side walls are angled to provide a tapered keyway for a respective frictional element and the frictional element tapers inwardly from its proximal to its distal end.

7. The brake shoe as claimed in claim 4 in which
the, or each, carrier has a passageway defined therein, the passageway being generally transverse to the spine of the brake shoe and co-parallel with the walls of its associated carrier; and
the locking means comprises a fastener that is received within the passageway and opposed ends of which are adapted to be tightened against the opposed proximal and distal ends of the respective frictional element associated with each carrier.

8. The brake shoe as claimed in claim 7 in which the fastener comprises a headed bolt having a threaded free end, a pair of washers and a nut, the washers bearing against opposed ends of the frictional element when the nut is tightened on the bolt and thereby preventing lateral movement of the frictional element with respect to the spine.

9. The brake shoe as claimed in any one of the preceding claims in which the, or each, frictional element is of a sintered material.

10. The brake shoe as claimed in claim 9 in which the, or each, frictional element is manufactured in a production process that creates no, or minimal, airborne fibres and does not require the use of phenol resins.

11. A drum brake incorporating at least one brake shoe as claimed in any one of claims 1 to 10.

12. A replaceable frictional element adapted for use in a brake shoe as claimed in any one of claims 1 to 10.
